(19) United States
(12) Patent Application Publication
(10) Pub. No.: US 2026/0039760 A1
(43) Pub. Date: Feb. 5, 2026

(54) SKEW ADJUSTMENT MECHANISM

(71) Applicant: GIGA-IMAGE Technology Co., Ltd., Taipei City (TW)

(72) Inventors: Ta-yi LEE, New Taipei City (TW); Yu chun LO, New Taipei City (TW)

(73) Assignee: GIGA-IMAGE Technology Co., Ltd., Taipei City (TW)

(21) Appl. No.: 19/094,912

(22) Filed: Mar. 30, 2025

(30) Foreign Application Priority Data
Jul. 31, 2024 (TW) 113208195

(51) Int. Cl. H04N 1/047; H04N 1/024

(52) U.S. Cl. CPC H04N 1/047; H04N 1/02481

(57) ABSTRACT

A skew adjustment mechanism for a scanning device includes a frame rack, an image sensor, a support frame, and a bearing base. The frame rack includes elastic elements on its bottom side and a guide slot positioned on its inner side edge. The image sensor, disposed on the frame rack, includes friction parts on two sides. The elastic elements abut against the two sides of the image sensor. The support frame, positioned below the frame rack, includes a fixing plane with a through hole for accommodating a penetrating element. The bearing base, cooperating with a guide rod to slide, supports the support frame and the frame rack. The penetrating element extends through the through hole into the guide slot and is fixed inside the frame rack. A skew angle of the image sensor is adjustable by changing a position of the penetrating element within the guide slot.

### CROSS REFERENCE TO RELATED APPLICATIONS

This application claims priority to Taiwan Application Serial No. 113208195, filed Jul. 31, 2024, the disclosure of which is incorporated herein by reference.

### FIELD OF DISCLOSURE

The present application relates to a skew adjustment mechanism, and more particularly to a skew adjustment mechanism applied to a scanning device.

### BACKGROUND

Currently, products such as flatbed scanners, multifunctional servo machines, and copiers predominantly use contact image sensors as image scanning modules. The image sensing module is designed to incorporate a supporting frame, providing a necessary elastic force to keep the contact image sensor in close contact with a scanning window glass and maintaining an adequate depth of field. A bearing housing is positioned below the supporting frame and provided with a bearing and a guide rod on each of two sides, wherein the guide rods on both sides are fixed to a lower cover of the bearing housing. With a belt fixing device disposed on one side of the bearing housing, motor power is transmitted to the supporting frame via a belt of the belt fixing device, thereby driving the contact image sensor to perform image scanning.

However, since the contact image sensor needs to move along a straight-line track, a clearance must be maintained between the bearings and the guide rods to minimize resistance and ensure smooth sliding. Consequently, when the belt on the side of the bearing housing drives the contact image sensor to move, the clearance may cause a slight skew deviation of the contact image sensor.

Furthermore, cumulative errors arising from manufacturing and assembly tolerances of an upper cover, the lower cover and other components of the image scanning module may cause skewing of an upper boundary of a scanned image. When such skewing issues occur on production line, the upper cover usually must be disassembled and certain components must be individually replaced to reduce the skew deviation, as there is no effective method for immediate correction.

Therefore, it not only increases maintenance time and component costs but also poses a risk of dust or other contaminants entering the contact image sensor, leading to secondary contamination.

In view of the foregoing, there is a need for a skew adjustment mechanism enabling prompt correction of the skewing of the image sensor while preventing contamination of components during the adjustment process. This issue is a significant concern in the field and needs to be addressed.

### SUMMARY OF DISCLOSURE

The present application provides a skew adjustment mechanism used to address the issues in the prior art.

In a first aspect, the present application provides a skew adjustment mechanism including a frame rack, an image sensor, a support frame, and a bearing base.

The frame rack includes a plurality of elastic elements and a guide slot positioned on an inner side edge of the frame rack, and the elastic elements respectively disposed on two sides of a bottom portion of the frame rack. The image sensor is disposed on the frame rack and includes a plurality of friction parts respectively positioned on two sides of the image sensor. The elastic elements respectively abut against the two sides of the image sensor. The support frame is positioned below the frame rack and includes a fixing plane extending upward toward one side of the frame rack, and a through hole formed on the fixing plane and configured to accommodate a penetrating element. The bearing base is configured to cooperate with a guide rod to slide.

The support frame is disposed on the bearing base, and the frame rack is rotatably disposed on the bearing base. The penetrating element passes through the through hole, extends into the guide slot, and is fixed to a fixing element located inside the frame rack. A skew angle of the image sensor is adjustable by changing a position of the penetrating element within the guide slot.

Optionally, in one embodiment of the present application, the support frame comprises a reference notch formed on an outer side of the support frame, and the frame rack comprises a shifting reference scale, wherein the reference notch and the shifting reference scale are configured to indicate a relative position of the support frame and the frame rack.

Optionally, in one embodiment of the present application, the frame rack comprises a fine-tuning element configured to drive the frame rack to maintain the reference notch within a range of the shifting reference scale while moving.

Optionally, in one embodiment of the present application, each of the friction parts is a friction pad or a friction wheel.

Optionally, in one embodiment of the present application, each of the friction parts comprises a hook extending downward from one side, and the hook is positioned below a limit part disposed at an edge of the frame rack.

Optionally, in one embodiment of the present application, the bearing base includes a shaft and a tenon. The shaft is disposed at a center of the bearing base and passing through the supporting frame and the frame rack. The tenon is positioned on the shaft and abutting against the frame rack downward.

Optionally, in one embodiment of the present application, the frame rack includes a limit slot configured for the tenon to pass through.

Optionally, in one embodiment of the present application, the bearing base is fixed to the support frame via two bearing fixing elements positioned respectively on two sides of the shaft.

In a second aspect, the present application provides a skew adjustment mechanism including a frame rack, an image sensor, a support frame and a bearing base.

The frame rack includes two elastic elements respectively disposed on two sides of a bottom portion of the frame rack, and a guide slot positioned on an inner side edge of the frame rack. The image sensor is disposed on the frame rack and includes a friction pad or a friction wheel respectively on each of two sides of an upper side of the image sensor, and the two elastic elements abut against two sides of the image sensor. The support frame is located below the frame rack and includes a fixing plane extending upward and toward one side of the frame rack, and a through hole formed on the fixing plane and configured to accommodate a penetrating element. The bearing base is configured to cooperate with a guide rod to slide.

The support frame is disposed on the bearing base, and the frame rack is rotatably disposed on the bearing base. The penetrating element passes through the through hole, extends into the guide slot, and is fixed to a fixing element located inside the frame rack. A skew angle of the image sensor is adjustable by changing a position of the penetrating element within the guide slot. The support frame comprises a reference notch formed on an outer side of the support frame, the frame rack comprises a shifting reference scale, and the reference notch and the shifting reference scale are configured to indicate a relative position of the support frame and the frame rack.

Optionally, in one embodiment of the present application, the frame rack comprises a fine-tuning element configured to drive the frame rack to maintain the reference notch within a range of the shifting reference scale while moving, when the penetrating element is loosened from the fixing element.

The present application offers the following beneficial effects: A skew angle of the image sensor is adjustable by changing the position of the penetrating element passing the through hole and extending into the guide slot. Furthermore, with an arrangement of the friction parts, the elastic elements and the limit part, the image sensor enables a simplified structure and limits the positions of each component for the skew adjustment mechanism, thereby preventing dislocation issues in the scanning device and ensuring that the image sensor remains in contact with a scanning window glass of the scanning device.

Additionally, the bearing base is configured to slide along the guide rod, and the support frame and the frame rack are constrained within upper and lower movement limits by the tenon and the shaft penetrating the support frame and the frame rack. The support frame and the frame rack can move relative to each other by using the penetrating element, thereby driving the frame rack and the image sensor to move and correcting the skew deviation. Moreover, in the present application, with an arrangement of the fine-tuning element, the guide slot, the reference notch and the shifting reference scale disposed on the support frame and the frame rack, an adjustment amount for the skew deviation of the skew adjustment mechanism can be standardized and also enables precise recording and the correction of the skew angle in conjunction with the bearing fixing element.

### BRIEF DESCRIPTION OF DRAWINGS

FIG. 1 illustrates an exploded perspective view of a skew adjustment mechanism in accordance with an embodiment of the present application.

FIG. 2 is an assembled perspective view of the skew adjustment mechanism in accordance with the embodiment of the present application.

FIG. 3 is a partial perspective view of the skew adjustment mechanism in accordance with the embodiment of the present application, showing a frame rack and a support frame of the skew adjustment mechanism from one side.

FIG. 4 is a partial cross-sectional view of the frame rack and the support frame in the skew adjustment mechanism in accordance with the embodiment of the present application.

FIG. 5 is an exploded perspective view of a side fixing mechanism of the frame rack and the support frame in the skew adjustment mechanism in accordance with the embodiment of the present application.

FIG. 6 is a side perspective view of the side fixing mechanism of the frame rack and the support frame in the skew adjustment mechanism in accordance with the embodiment of the present application.

FIG. 7 is a top perspective view of the frame rack, the support frame, and a bearing base before being locked in the skew adjustment mechanism in accordance with the embodiment of the present application.

FIG. 8 is a top perspective view of the frame rack, the support frame and the bearing base after being locked in the skew adjustment mechanism in accordance with the embodiment of the present application.

FIG. 9 is a bottom perspective view of the frame rack, the support frame and the bearing base after being locked in the skew adjustment mechanism in accordance with the embodiment of the present application.

### DETAILED DESCRIPTION

Exemplary embodiments will now be described in detail with reference to the accompanying drawings. However, these embodiments can be implemented in various forms and should not be construed as limiting. Rather, they are provided to enhance the understanding of the present disclosure and to fully convey its concept to those skilled in the art. Furthermore, the specific embodiments described herein are for illustrative purposes only and do not limit the present application.

Please refer to the drawings, in which identical reference numerals denote identical components.

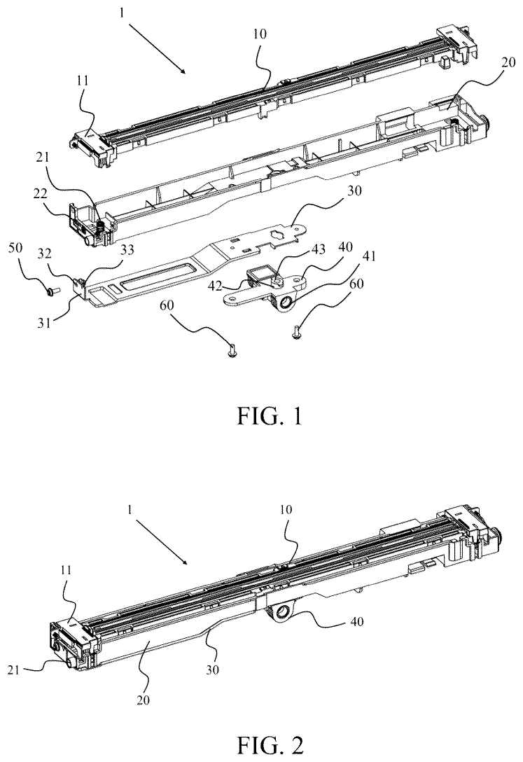

Referring to FIG. 1 and FIG. 2, FIG. 1 and FIG. 2 illustrate respectively an exploded perspective view and an assembled perspective view of a skew adjustment mechanism 1 according to an embodiment of the present application. As shown in the figures, the skew adjustment mechanism 1 provided in the present application is applied to a scanning device and includes an image sensor 10, a frame rack 20, a support frame 30, and a bearing base 40.

The frame rack 20 includes a plurality of elastic elements 21 disposed on two sides of a bottom portion of the frame rack 20, and a guide slot 22 disposed on an inner side edge of the frame rack 20. The image sensor 10 is disposed on the frame rack 20 and includes a plurality of friction parts 11 respectively positioned on two sides of the image sensor 10, wherein the elastic elements 21 abutting against the two sides of the image sensor 10.

The support frame 30 is positioned below the frame rack 20 and includes a fixing plane 31 and a through hole 32 formed on the fixing plane 31. The fixing plane 31 extends upward toward one side of the frame rack 20, and the through hole 32 is configured to accommodate a penetrating element 50. The bearing base 40 comprises a bearing perforation 41 configured to cooperate with a guide rod (not shown) for sliding. The support frame 30 is disposed on the bearing base 40, and the frame rack 20 is rotatably disposed on the bearing base 40.

The penetrating element 50 passes the through hole 32 and extends into the guide slot 22. A skew angle of the image sensor is adjustable by the support frame 30 and the frame rack 20 adjusts by changing a position of the penetrating element 50 within the guide slot 22.

With the skew adjustment mechanism 1 provided in the present application, manufacturers can efficiently maintain scanning devices for customers without requiring disassembly of the image sensor 10. Furthermore, a skew status of the scanning device can be checked by viewing the frame rack 20 and the support frame 30 to allow an adjustment amount for skew deviation of the skew adjustment mechanism 1 to be standardized. For example, a relative position of the frame rack 20 and the support frame 30 is quantified into multiple scale units, when edge blur appears in the scanned image, it may be corrected by adjusting one scale unit, whereas if the scanned image shows skew, it may require adjusting at least two scale units. Thus, the skew adjustment mechanism 1 of the present application enables timely and effective resolution of imaging issues without frequent component replacement.

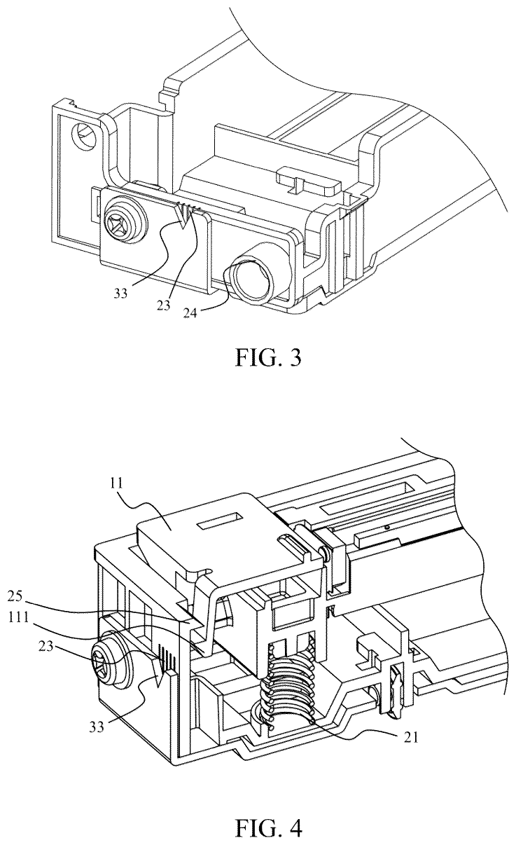

Specifically, referring to FIG. 3, FIG. 3 is a partial perspective view showing the frame rack 20 and the support frame 30 in the skew adjustment mechanism 1 from one side according to the embodiment of the present application. In the embodiment, a reference notch 33 is formed on an outer side of the support frame 30, and a shifting reference scale 23 is formed on the frame rack 20. The skew adjustment mechanism 1 utilizes the reference notch 33 and the shifting reference scale 23 to indicate the relative position of the support frame 30 and the frame rack 20.

Furthermore, as shown in FIG. 3, in the embodiment of the present application, the frame rack 20 includes a fine-tuning element 24 configured to drive the frame rack 20 to maintain the reference notch 33 within a range of the shifting reference scale 23 while moving.

In an embodiment of the present application, the frame rack 20 is made of plastic, while the support frame 30 is made of metal. The reference notch 33 may be formed through metal shaping, and the shifting reference scale 23 may be precisely positioned on a surface of the plastic frame rack 20.

In an embodiment of the present application, the fixing plane 31 is perpendicular to a bottom surface of the support frame 30 to facilitate the assembly of the support frame 30 with the frame rack 20, while ensuring the accuracy of the scale indicated by the reference notch 33 and the shifting reference scale 23.

Referring to FIG. 4, FIG. 4 illustrates a partial cross-sectional view of the frame rack and the support frame in the skew adjustment mechanism according to an embodiment of the present application. In this embodiment, each of the friction parts 11 is a friction pad or a friction wheel, ensuring the image sensor 10 maintains a predetermined distance from a measurement object and achieves an adequate depth of field. The image sensor 10 may be a contact image sensor.

Referring to FIG. 4, in the embodiment of the present application, the each of friction part 11 comprises a hook 111 extending downward from one side, and the hook 111 is positioned below a limit part 25 disposed at an edge of the frame rack 20. Consequently, the support frame 30 and the frame rack 20 are constrained within upper and lower movement limits by the tenon 43 and the shaft 42 penetrating the support frame 30 and the frame rack 20. Additionally, incorporating with the penetrating element 50, the frame rack 20 and the image sensor 10 are driven synchronously to adjust the skew deviation.

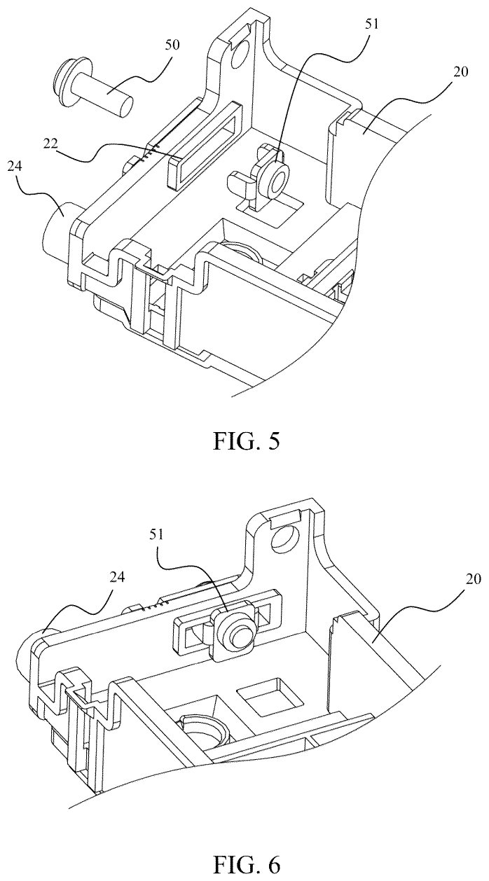

Referring to FIG. 5 and FIG. 6, FIG. 5 is an exploded perspective view of a side fixing mechanism of the frame rack 20 and the support frame 30 in the skew adjustment mechanism according to an embodiment of the present application, and FIG. 6 is a side perspective view of the side fixing mechanism. In this embodiment, the penetrating element 50 corresponds to a fixing element 51 located inside the frame rack 20. Once an adjustment angle of the skew adjustment mechanism 1 is determined, the penetrating element 50 is locked into the fixing element 51 to complete the skew adjustment process. When the skew adjustment mechanism 1 requires further adjustment, the penetrating element 50 is loosened from the fixing element 51, allowing both the penetrating element 50 and the fixing element 51 to move within the guide slot 22. Once the relative position of the frame rack 20 and the support frame 30 is confirmed, the penetrating element 50 and the fixing element 51 are locked again.

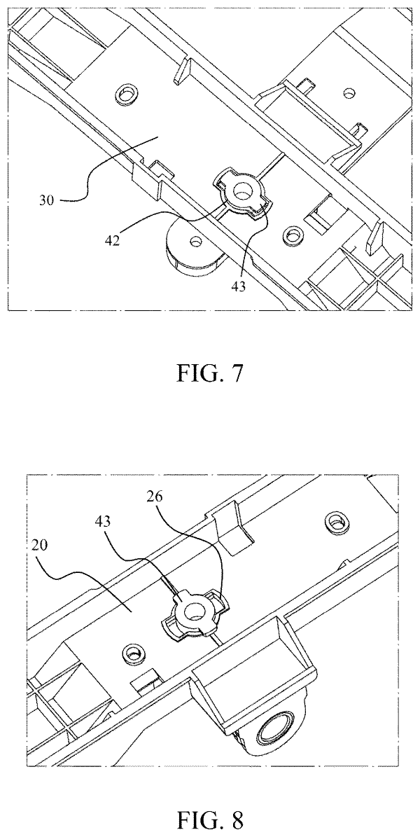

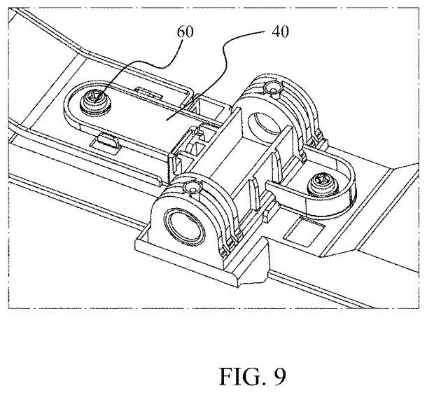

Referring to FIG. 7, FIG. 8, and FIG. 9, FIG. 7 is atop perspective view of the frame rack, the support frame, and the bearing base before being locked in the slew adjustment mechanism according to an embodiment of the present application. FIG. 8 and FIG. 9 are a top perspective view and a bottom perspective view, respectively, of the frame rack, the support frame, and the bearing base after locking in accordance with the embodiment. In this embodiment, a shaft 42 and a tenon 43 are centrally disposed on the bearing base 40, the shaft 42 passes through the support frame 30 and the frame rack 20, and the tenon 43 is engaged with the shaft 42 and abuts downward against the frame rack 20 to constrain the vertical movement of the support frame 30 and the frame rack 20.

Referring again to FIG. 8, the frame rack 20 includes a limit slot 26 for the passage of the tenon 43, thereby constraining the frame rack 20 and the support frame 30 from the inside and further limiting their movement.

Referring again to FIG. 9, the bearing base 40 is fixed to the support frame 30 via two bearing fixing elements 60 positioned on two sides of the shaft 42 to prevent the bearing base 40 from rotating relative to the support frame 30 when the scanning device is performing a scanning operation.

The present application provides at least the following beneficial effects: The embodiments of the present application enable timely adjustment of the skew angle of the image sensor by changing the position of the penetrating element passing the through hole and extending into the guide slot. Furthermore, the image sensor incorporates an arrangement of the friction parts, the elastic elements and the limit part to simplify the structure and limit the positions of components in the skew adjustment mechanism, thereby preventing dislocation issues in the scanning device and ensuring the image sensor maintains the predetermined distance from the measurement object to achieve the adequate depth of field. Additionally, the bearing base is configured to slide along the guide rod, and the support frame and the frame rack are constrained within upper and lower movement limits by the tenon and the shaft penetrating the support frame and the frame rack. The support frame and the frame rack can move relative to each other by using the penetrating element, thereby driving the frame rack and the image sensor to move and correcting the skew deviation, therefore imaging issues can be resolved timely and effectively. Moreover, in the present application, with an arrangement of the fine-tuning element, the guide slot, the reference notch and the shifting reference scale respectively disposed on the support frame and the frame rack, the adjustment amount for the skew deviation of the skew adjustment mechanism can be standardized, and also enables precise recording and the correction of the skew angle in conjunction with the bearing fixing element.

It should be noted that while the combination of components in this invention preferably forms the described embodiments, this should not be construed as a limitation of the present application. The components disclosed herein may be combined in various additional ways beyond the described embodiments.

What is claimed is:

1. A skew adjustment mechanism applied to a scanning device, comprising:
a frame rack, comprising:
a plurality of elastic elements respectively disposed on two sides of a bottom portion of the frame rack, and
a guide slot positioned on an inner side edge of the frame rack;
an image sensor disposed on the frame rack and comprising a plurality of friction parts respectively positioned on two sides of the image sensor, wherein the elastic elements respectively abut against the two sides of the image sensor;
a support frame positioned below the frame rack, comprising:
a fixing plane extending upward toward one side of the frame rack; and
a through hole formed on the fixing plane and configured to accommodate a penetrating element; and
a bearing base configured to cooperate with a guide rod to slide, wherein the support frame is disposed on the bearing base, and the frame rack is rotatably disposed on the bearing base;
wherein the penetrating element passes the through hole, extends into the guide slot, and is fixed to a fixing element located inside the frame rack; and
wherein a skew angle of the image sensor is adjustable by changing a position of the penetrating element within the guide slot.

2. The skew adjustment mechanism according to claim 1, wherein the support frame comprises a reference notch formed on an outer side of the support frame, and the frame rack comprises a shifting reference scale, wherein the reference notch and the shifting reference scale are configured to indicate a relative position of the support frame and the frame rack.

3. The skew adjustment mechanism according to claim 2, wherein the frame rack comprises a fine-tuning element configured to drive the frame rack to maintain the reference notch within a range of the shifting reference scale while moving.

4. The skew adjustment mechanism according to claim 1, wherein each of the friction parts is a friction pad or a friction wheel.

5. The skew adjustment mechanism according to claim 1, wherein each of the friction parts comprises a hook extending downward from one side, and the hook is positioned below a limit part disposed at an edge of the frame rack.

6. The skew adjustment mechanism according to claim 1, wherein the bearing base comprises:
a shaft disposed at a center of the bearing base and passing through the supporting frame and the frame rack, and
a tenon positioned on the shaft and abutting against the frame rack downward.

7. The skew adjustment mechanism according to claim 6, wherein the frame rack comprises a limit slot configured for the tenon to pass through.

8. The skew adjustment mechanism according to claim 6, wherein the bearing base is fixed to the support frame via two bearing fixing elements positioned respectively on two sides of the shaft.

9. A skew adjustment mechanism applied to a scanning device, comprising:
a frame rack comprising:
two elastic elements respectively disposed on two sides of a bottom portion of the frame rack, and
a guide slot positioned on an inner side edge of the frame rack;
an image sensor disposed on the frame rack and comprising a friction pad or a friction wheel respectively on each of two sides of an upper side of the image sensor, wherein the two elastic elements abut against two sides of the image sensor;
a support frame located below the frame rack and comprising:
a fixing plane extending upward and toward one side of the frame rack, and
a through hole formed on the fixing plane and configured to accommodate a penetrating element; and
a bearing base configured to cooperate with a guide rod to slide, wherein the support frame is disposed on the bearing base, and the frame rack is rotatably disposed on the bearing base;
wherein the penetrating element the penetrating element passes the through hole, extends into the guide slot, and is fixed to a fixing element located inside the frame rack;
wherein a skew angle of the image sensor is adjustable by changing a position of the penetrating element within the guide slot; and
wherein the support frame comprises a reference notch formed on an outer side of the support frame, the frame rack comprises a shifting reference scale, and the reference notch and the shifting reference scale are configured to indicate a relative position of the support frame and the frame rack.

10. The skew adjustment mechanism according to claim 9, wherein the frame rack comprises a fine-tuning element configured to drive the frame rack to maintain the reference notch within a range of the shifting reference scale while moving, when the penetrating element is loosened from the fixing element.
